(19) United States
(12) Patent Application Publication
(10) Pub. No.: US 2018/0357654 A1
(43) Pub. Date: Dec. 13, 2018

(54) TESTING AND EVALUATING PREDICTIVE SYSTEMS

(71) Applicant: Microsoft Technology Licensing, LLC, Redmond, WA (US)

(72) Inventors: Yifei Huang, Redmond, WA (US); Xinying Song, Bellevue, WA (US); Ankit Gupta, Seattle, WA (US); Jianfeng Gao, Woodinville, WA (US); Prabhdeep Singh, Newcastle, WA (US); Salman Mukhtar, Seattle, WA (US)

(21) Appl. No.: 15/617,363

(22) Filed: Jun. 8, 2017

(51) Int. Cl. G06Q 30/02; G06N 5/04; G06F 17/11; G06F 17/18; G06N 99/00

(52) U.S. Cl. CPC G06Q 30/0206; G06Q 30/0202; G06N 99/005; G06F 17/11; G06F 17/18; G06N 5/04

(57) ABSTRACT

Methods, systems, and computer programs are presented for evaluating the accuracy of predictive systems and quantifiable measures of incremental value. One method provides a scientific solution to test and evaluate predictive systems in a transparent, rigorous, and verifiable way to allow decision-makers to better decide whether to adopt a new predictive system. In one example, objects to be evaluated are assigned to a control group or an experiment group. The testing provides an equal or better distribution of scores in the control group for the scores obtained with the first predictor, but the method aims at maximizing the scores of objects obtained with the second predictor in the experiment group. Since the first scores are evenly distributed in both groups, any result improvements may be attributed to the better accuracy of the second predictor when the results of the experiment group are better than the results of the control group.

### TECHNICAL FIELD

The subject matter disclosed herein generally relates to methods, systems, and programs for predicting the value of an object and, more particularly, methods, systems, and computer programs for evaluating predictive systems.

### BACKGROUND

Analytics, data science, and predictive systems are becoming key for companies that process large amounts of data, but some companies are reluctant to deploy predictive systems because of concerns about their accuracy. Some of the concerns include the inability to accurately test predictive systems and the inability to validate test results in large-scale production environments.

For vendors of artificial intelligence (AI) systems, it is important to have scientific proof that their AI systems generate better predictions than existing solutions. Otherwise, it is difficult to encourage clients to replace their current systems with new, better, more accurate AI systems. Further, understanding the accuracy of AI systems helps in determining their value to customers and how to price AI services accordingly.

### BRIEF DESCRIPTION OF THE DRAWINGS

Various ones of the appended drawings merely illustrate example embodiments of the present disclosure and cannot be considered as limiting its scope.

FIG. 1 illustrates an example embodiment for A/B testing.

FIG. 2 illustrates a method for comparing the performance of two predictors, according to some example embodiments.

FIG. 3 illustrates an example embodiment for comparing the performance of the two lead predictors.

FIG. 3B illustrates the processing of an incoming lead in a dynamic system, according to some example embodiments.

FIG. 4 is a flowchart of a method for comparing the performance of the two predictors, according to some example embodiments.

FIG. 5 illustrates the dynamic assignment of incoming leads to a group, according to some example embodiments.

FIG. 6 is a diagram of a system for implementing embodiments.

FIG. 7 is a chart showing example results.

FIG. 8 is a flowchart of a method for evaluating the accuracy of predictive systems, according to some example embodiments.

FIG. 9 is a block diagram illustrating an example of a machine upon which one or more example embodiments may be implemented.

### DETAILED DESCRIPTION

Example methods, systems, and computer programs are directed to evaluating the accuracy of predictive systems. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Embodiments provide a scientific solution to test and evaluate predictive systems in a transparent, rigorous, and verifiable way to assist decision-makers to decide when and how to adopt new predictive systems based on reliable test results.

Previous solutions for testing predictive systems include offline testing using historical data, retrospective simulations, and live concept testing, where predictions are recorded, acted upon, and evaluated after the outcome. There are several important limitations and disadvantages in these approaches. First, these methods lack transparent and credible metrics that can quantify the business impact of predictive accuracy improvements. Second, these methods do not support field testing scenarios where a predictive system in testing is used for a fraction of actual, real-life operations, instead of being able to make predictions independently of actual operations.

The embodiments presented improve the methodology of standard randomized controlled tests (e.g., “A/B testing”). A/B testing randomly splits objects into experiment and control groups, and compares the performance of these two groups. The random splitting of the experiment and control groups does not ensure that the mix of entities in the two groups is equal. Consequently, a large sample size is needed to gather statistically credible results.

The arbitrage test presented herein has two significant improvements compared to A/B testing. First, the arbitrage test relies upon principles of dynamic pricing, to make real-time predictions on each incoming object, and to make an arbitrage decision on whether to include the incoming object into the experiment group. This ensures that the mix of entities in the experiment and control groups is substantially equal at all times since decisions are made for all entities, thus reducing the time to collect statistically relevant results. Second, A/B testing is tied to a specific policy on how to use the predictive system. In practice, a core predictive system can be used for multiple purposes and the performance for each purpose depends on the intrinsic accuracy of the predictive system. The embodiments presented overcome this limitation by assessing the intrinsic accuracy and practical significance of the predictive system, which is not limited to a particular method for using the predictive system.

The presently described “arbitrage test with first-order stochastic dominance constraint for fair comparison” (ATFSD) framework (the “arbitrage test” framework hereafter) ensures a fair comparison between the experiment group (using the predictive system in test) and the control group (using the existing or alternative system). Second, the presently described “real-time arbitrage algorithm using dynamic pricing” (RTADP) framework provides the algorithm to construct the experiment and control groups by solving the constraint optimization problem imposed by the arbitrage test framework. The RTADP operationalizes the predictive system during testing to make arbitrage decisions about whether to include an incoming object (e.g., the object whose value has to be predicted by the system) into the experiment group. Third, the arbitrage test provides a faster, more agile, and less interruptive way of testing than the standard A/B testing because of the effectiveness of leveraging the full evaluation sample (rather than only leveraging the experiment group sample).

By reducing the cost of potential interruptions of existing business processes, the arbitrage test provides a competitive alternative because the arbitrage test is more likely to be adopted by decision makers.

One general aspect includes a method including an operation for setting testing parameters to evaluate a first predictor and a second predictor. The first predictor is configured to calculate a first score for an object, and the second predictor is configured to calculate a second score for the object. The first score and the second score provide a prediction of the value of the object. The method further includes receiving, by one or more processors, a plurality of objects. For each object from the plurality of objects, the method calculates the first score and the second score for the object, and assigns the object to one of a control group or an experiment group based on the first score, the second score, and the testing parameters. The distribution of first scores in the control group is equal or better than the distribution of first scores in the experiment group. Further, the assigning includes a goal to have greater second scores in the experiment group than in the control group. The method further includes operations for measuring the value of the plurality of objects, and for comparing the values of the objects in the control group to the values of the objects in the experiment group. The method also includes determining that the second predictor is more accurate than the first predictor for predicting the value of objects based on the comparison of the values of the objects, and causing presentation, to a user, of the determination.

One general aspect includes a system including: a memory including instructions; and one or more computer processors, where the instructions, when executed by the one or more computer processors, cause the one or more computer processors to perform operations including: setting testing parameters for evaluating a first predictor and a second predictor, the first predictor being configured to calculate a first score for an object, the second predictor being configured to calculate a second score for the object, the first score and the second score providing a prediction of a value of the object; and receiving a plurality of objects. For each object from the plurality of objects, the one or more computer processes calculate the first score and the second score for the object, and assign the object to one of a control group or an experiment group based on the first score, the second score, and the testing parameters. The distribution of first scores in the control group is equal to or better than the distribution of first scores in the experiment group. Further, the assigning includes a goal to have greater second scores in the experiment group than in the control group. The operations further include: measuring the value of the plurality of objects; comparing the values of the objects in the control group to the values of the objects in the experiment group; determining that the second predictor is more accurate than the first predictor for predicting the value of objects based on the comparison of the values of the objects; and causing presentation, to a user, of the determination.

One general aspect includes a non-transitory machine-readable storage medium including instructions that, when executed by a machine, cause the machine to perform operations including: setting testing parameters for evaluating a first predictor and a second predictor, the first predictor being configured to calculate a first score for an object, the second predictor being configured to calculate a second score for the object, the first score and the second score providing a prediction of a value of the object; and receiving a plurality of objects. For each object from the plurality of objects, the one or more computer processes calculate the first score and the second score for the object, and assign the object to one of a control group or an experiment group based on the first score, the second score, and the testing parameters. The distribution of first scores in the control group is equal to or better than the distribution of first scores in the experiment group. Further, the assigning includes a goal to have greater second scores in the experiment group than in the control group. The operations further include: measuring the value of the plurality of objects; comparing the values of the objects in the control group to the values of the objects in the experiment group; determining that the second predictor is more accurate than the first predictor for predicting the values of objects based on the comparison of the values of the objects; and causing presentation, to a user, of the determination.

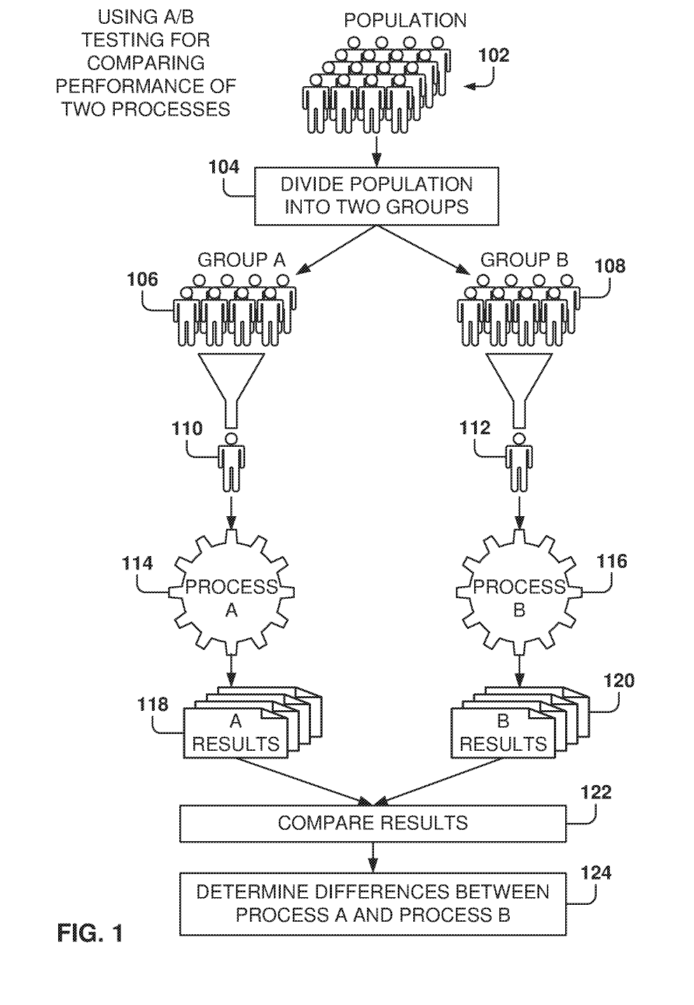

FIG. 1 illustrates an example embodiment for A/B testing. A/B testing is a term for a randomized experiment with two variants, A and B, which are the control and variation groups in the controlled experiment. The two groups are run through one or more tests or functions and the results obtained by the two groups are compared to determine if the difference between the variants produces different results. A/B testing is a way to compare two versions of a single variable, typically by testing the results of using variable A and variable B, and then determining which of the two variables is more effective.

For example, A/B testing may be used to change pages in a website and determine if the changes have an impact on business, or to change the content of an email sent to clients and observe if the responses are different, etc.

FIG. 1 illustrates an A/B testing method for testing two processes (process A and B) to observe the different responses when using one process or the other. The processes may refer to being exposed to a different user interface, different wait times on a queue, predictor of a value assigned to each object (as discussed in more detail below), etc. Each process performs an operation that is related to the object and generates a result (e.g., success or failure, user responds or not, a quality metric obtained from a user's response, etc.)

Initially, a population 102 of objects (e.g., sales leads) is identified, and then, at operation 104, the population 102 is divided into two groups: group A 106 and group B 108. Although the example of FIG. 1 shows the same number of objects in each group, in other examples, the groups may have a different number of objects.

Each object is then selected for performing one of the processes: object 110 from group A 106 is used to perform process A 114, and object 112 from group B 108 is used to perform process B 116. Although it is shown that one object at a time is used for the respective process, other embodiments may use parallel processing.

The results 118 of process A 114 are compared to the results 120 of process B 120 at operation 122. For example, statistical averages may be calculated for results A and results B, and the averages are then compared for significant differences. In other embodiments, other statistical measures may be used, such as the median, the geometric average, the maximum or minimum, etc.

At operation 124, the differences between the process A and the process B are determined based on the results comparison, and conclusions regarding A/B testing are obtained based on the differences.

As discussed earlier, there could be problems with A/B testing that may cause obtaining wrong or inconclusive results. For example, if the distribution of individuals between the groups is not homogeneous, the results may be skewed to the uneven distribution of individuals in the control and the experiment group. Further, with respect to evaluating predictive systems, A/B testing is tied to a specific function; however, a core predictive system may be used for multiple purposes, and the performance for each purpose depends on the intrinsic accuracy of the predictive system. The embodiments presented overcome this limitation by assessing the intrinsic accuracy and practical significance of the predictive system, which is not limited to a particular method for using the predictive system.

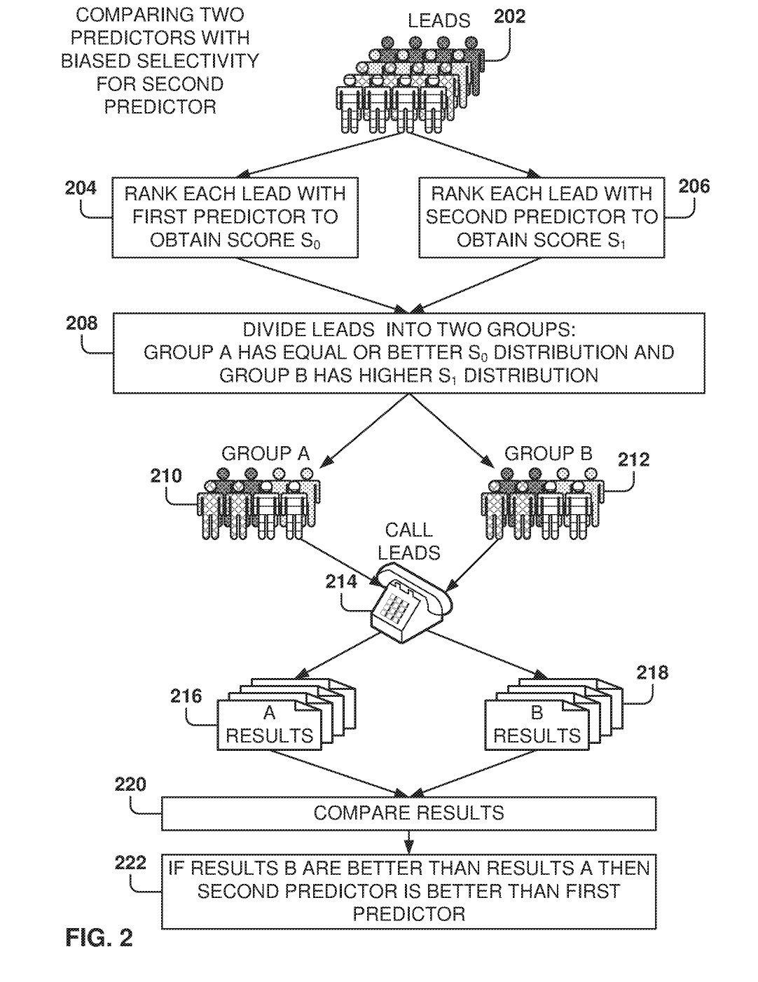

FIG. 2 illustrates a method for comparing the performance of two predictors, according to some example embodiments. As used herein, an object is an item that is received by the system in order to test the performance of the object for a certain function. In some example embodiments, the object is a lead received by a call center and the function is the ability of the call center to turn the lead into a sale. Further, a predictor is a function or program that predicts or estimates the value of the lead, which is measured as the probability that the lead results in a sale.

It is noted that the embodiments presented are described with reference to leads received in a call center, but the same principles may be applied to other types of objects, other types of functions, and other types of predictors. The embodiments presented should therefore not be interpreted to be exclusive or limiting, but rather illustrative.

FIG. 2 illustrates how to compare two predictors of the value of a lead with biased selectivity for the second predictor. When creating the two groups, a first goal is to have a similar distribution of the first predictor values in the control and the experiment group. A second goal, associated with the biased selectivity for the second predictor, is having a better distribution of the second predictor values in group B than in group A, while maintaining the first goal. This means that the control group and the experiment group are about the same with reference to the first predictor, and the results for the two groups would be similar if the first predictor where perfectly accurate. Further, by including better values from the second predictor in the experiment group, it is possible to determine if the second predictor is better than the same predictor, because if the second predictor is better, then the results from the experiment group (e.g., group B) would be better than the results from the control group (e.g., group A).

A plurality of leads 202 are received. At operation 204, the leads are ranked (e.g., scored) with the first predictor, also referred to as the legacy predictor, to obtain a first score S₀, and at operation 206, the leads 202 are ranked with the second predictor, also referred to as the new predictor, to obtain a second score S₁.

At operation 208, the leads 202 are divided into two groups: group A 210 (e.g., the control group) and group B 212 (e.g., the experiment group). As illustrated in FIG. 2, the icons represent leads, and their different shadings represent a category of the score S₀ generated by the first predictor. For example, four buckets or bins are defined for the range of S₀ (e.g., 0 to 1), and each shade is associated with a respective bucket.

The first goal of having equal or better distribution of S₀ in the control group may be expressed as follows:

P(C≥S₀)≥P(E≥S₀) for any S₀, (1)

where C is the control group and E is the experiment group. Therefore, the equation indicates that the probability that the number of leads in the control group exceeds a given score S₀ is always greater than the probability that the number of leads in the experiment group exceeds the given score S₀, for any value of S₀. That is, the control group will have the same or better S₀ scores than the experiment group.

Enforcing that this condition is imposed for all values of S₀ is more stringent than simply comparing averages, because while calculating averages, there could be some tradeoffs of scores to reach the same average, but an unbalanced distribution of scores. The S₀ distribution in the control group will be equal to or better than the S₀ distribution in the experiment group. Sometimes, the S₀ distribution will be similar in both groups, but because the leads arrive sequentially in time, it may not be possible to have the exact same distribution. In this case, the control group will have an advantage in S₀ scores, but as the number of leads grows, the distribution of scores in both groups may be about the same.

The goal of having a higher distribution of S₁ scores in the experiment group may be simply expressed as “cherry picking” better S₁ scores for the experiment group. The test will cherry pick the best S₁ scores for the experiment group while keeping the S₀ distribution similar on both groups. In other words, to solve the constraint optimization, the system constructively creates an arbitrage position. The arbitrage position is a binary decision: put the lead in the experiment group (e.g., arbitrage the lead) or put the lead in the control group (no arbitrage for the lead).

As illustrated in FIG. 2, groups A and B have similar distribution of S₀ scores. However, the arbitrage goal assigns as high as possible values of S₁ to group B while maintaining the goal to have the same distribution of S₀ in both groups (or better in the control group).

After the leads are assigned to groups, the leads are transferred to a call center where sales representatives follow up on the leads by calling potential customers 214. If the lead is converted into a sale, the lead is considered a success, while if the lead is not converted into a sale, the lead is considered a failure.

The results of following up on the leads are collected for group A (results 216) and group B (results 218). At operation 220, the results 216 from group A and the results 218 from group B are compared. In some example embodiments, the percentage of leads converted into sales is used as the metric for comparing performance. If the percentage of leads converted is significantly better for group B, then, in operation 222, the difference is attributed to the second predictor, because according to the first predictor, both groups should yield similar results.

Often, the volume of leads exceeds the capacity of the call center to follow up on those leads. Therefore, it is very important to prioritize the leads by choosing the leads with a better chance of conversion. This is why a better predictor will result in better leads, a higher conversion rate, and an increase in business sales.

In some example embodiments, the first predictor is a predictor already being used in the cell center, the second predictor is a new predictor that is arguably better than the first predictor, and the goal is to prove scientifically that the second predictor is better, without disturbing the normal operation of the call center. In some example embodiments, the second predictor is a machine-learning program that uses customer data to predict the value of the lead. The goal is to evaluate the second predictor as a replacement of the first predictor and measure the expected income improvement in the conversion rates of the leads.

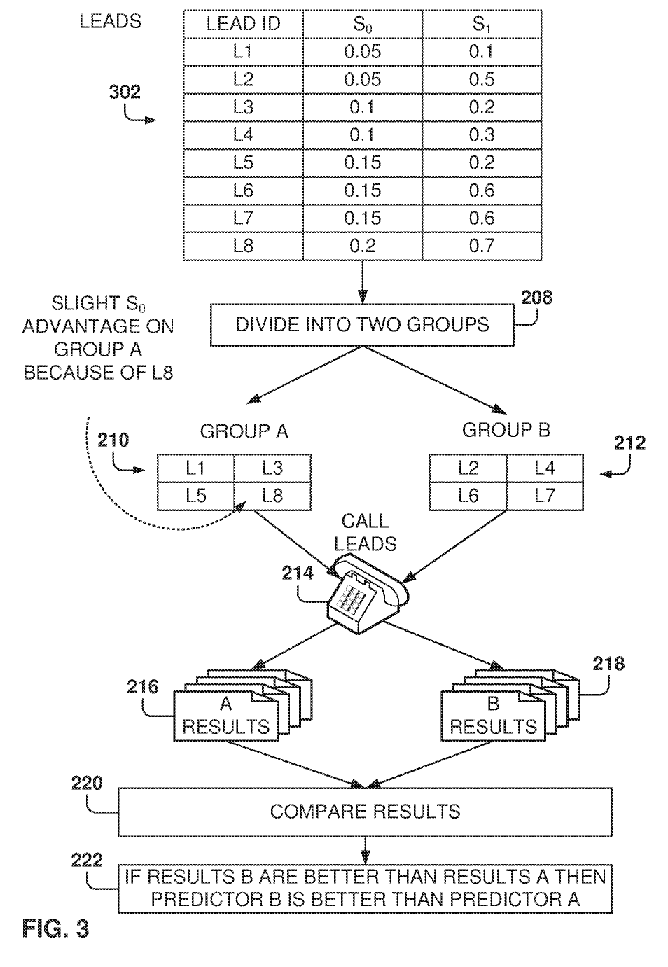

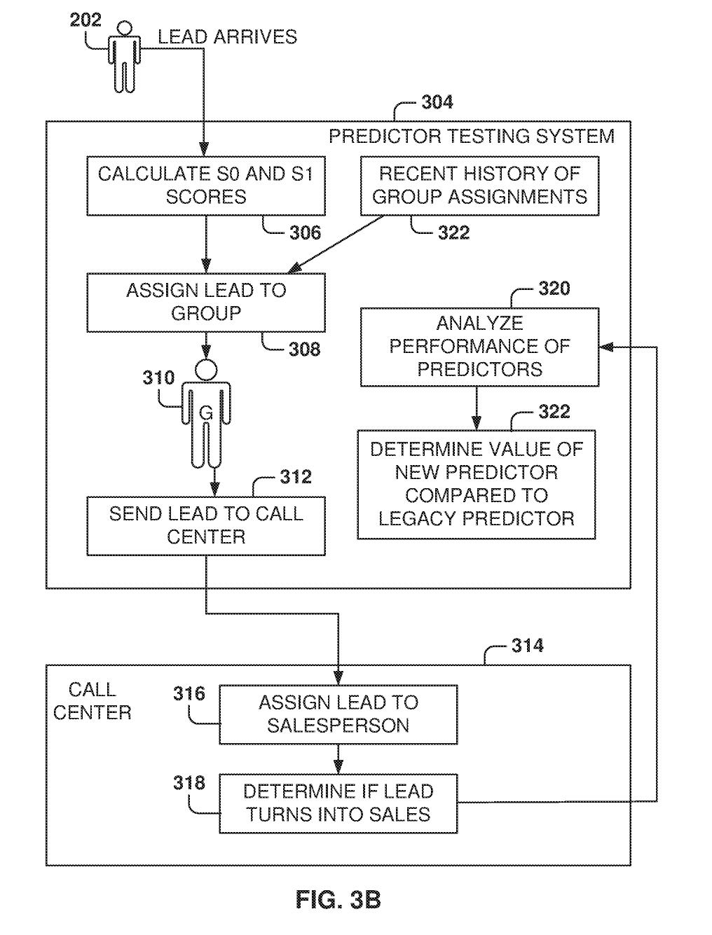

FIG. 3 illustrates an example embodiment for comparing the performance of the two predictors. In this example, limited to a small number of leads for simplicity of description, there are eight leads arriving to the predictor test system. Table 302 shows the leads, with the first column showing the lead ID L₁-L₈, the second column showing the S₀ score, and the third column showing the S₁ score. The example illustrates how the leads are divided, in operation 208, into the control group and the experiment group.

The first two leads, L₁ and L₂, have the same S₀ score of 0.05 but different S₁ scores, 0.1 and 0.5, respectively. Since they have the same S₀ score, one is assigned to each group, and because of the second goal to “cherry pick” the best S₁ score, L₂ is assigned to group B because of the better S₁ score. Similarly, L₃ and L₄ have the same S₀ score in different S₁ score, so the highest S₁ score, L₄, is selected for group B. Similarly, L₅ is selected for group A and L₆ is selected for group B because L₆ has a higher S₁ score.

However, when comparing L₇ and L₈, L₈ has better S₀ and S₁ scores than L₇. Since the first goal is to have equal or better S₀ scores in the control group (e.g., group A), L₈ is assigned to group A and L₇ is assigned to group B. Because the S₀ score of L₈ is better than L₇, group A has now a slight advantage with regards to the distribution of S₀ scores.

FIG. 3B illustrates the processing of an incoming lead 202 in a dynamic system, according to some example embodiments. In some example embodiments, most leads come at random times and in sequential order. Therefore, instead of categorizing all the leads together, the system has to categorize the lead into the control group or the experiment group at the time that the lead arrives to the system.

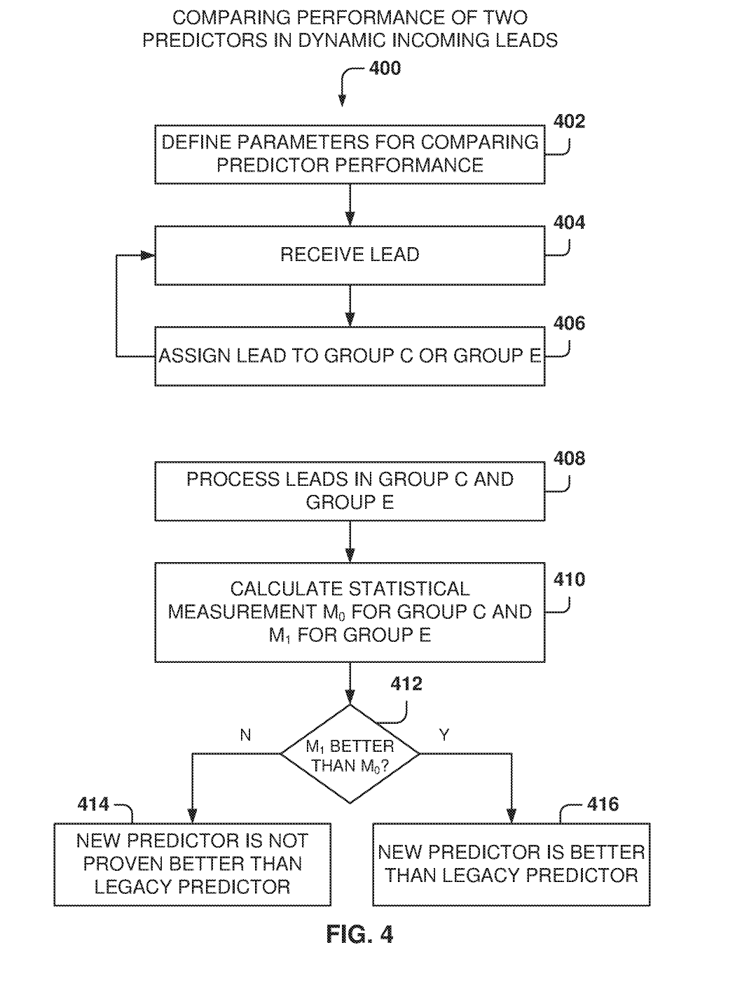

At operation 306, the S₀ and S₁ scores are calculated. The predictor testing system 304 keeps track of the recent history of group assignments 322 in order to assign the lead to a group and fulfill the desired parameters for the testing, as described in more detail below with reference to FIG. 4.

The lead 310, with the corresponding group assignment, is then sent to the call center 314 at operation 312. The call center 314 assigns the lead 310 to a salesperson at operation 316. At operation 318, a determination is made if the lead turns into a sale, e.g., the lead is a success or a failure.

The call center 314 sends the results to the predictor testing system 304, and, at operation 320, the performance of the predictors is analyzed based on the results received from the call center. At operation 322, a determination is made based on the analysis at operation 320, the determination indicating if the new predictor is better than the legacy predictor for calculating the value of leads in order to convert the leads into sales.

FIG. 4 is a flowchart of a method for comparing the performance of the two predictors, according to some example embodiments. The process of assigning objects to the control group C or the experiment group E becomes more complicated when the leads arrive at random times, instead of having all the leads available to select the best distribution for the leads. A decision needs to be made in real time on whether to assign the lead to group C or group E.

The first task is to dynamically estimate the distribution of the leads to perform the group assignment in real-time. Another challenge is that the condition described above in equation (1) is hard to satisfy because it has to be satisfied for any value of S₀. It is also noted that the control group and the experiment group do not to have to be of the same size. For example, the experiment group may be half the size of the control group, or 10% the size, etc. Thus, the testing of the new predictor may be performed on a small population of leads, while still obtaining reliable results.

The ATFSD uses some of the arbitrage concepts used in a market. If a participant in the market has better information than others, the participant may gain advantage by leveraging the known information. In this case, the distribution of S₀ scores remains about the same between the control group and the experiment group, but the better scoring provided by the second predictor means that some undervalued or overvalued objects may be found and this information used to the benefit of the arbiter.

At operation 402, the parameters for the arbitrage testing are defined. These parameters for the arbitrage testing include the predictive scoring function P₀ that calculates S₀, also referred to as the legacy predictive scoring function or legacy predictor, which serves as a baseline. In some example embodiments, S₀ is in the range from 0 to 1, but other ranges may also be utilized.

The parameters further include the predictive scoring function P₁ that calculates S₁, also referred to as the new predictive scoring function or new predictor. In some example embodiments, S₁ is in the range from 0 to 1, but other ranges may also be utilized.

The testing parameters further include a leads stream L {(l₁, l₂, l₃, . . . , l_{T}}, which are objects to be scored by both predictive systems. The leads arrive sequentially in time, although at random times. The lead arrival time is referred to as Lt={l₁, l₂, l₃, . . . , lₜ}.

Each lead is scored by the two predictive systems as they arrive. The scores are calculated as follows:

S₀ₜ=P₀(lₜ) (2)

Sₗₜ=P₁(lₜ) (3)

The parameters further include the target lead traffic ratio α, which is the fraction of object traffic that is routed into the experiment group.

The problem may be stated as splitting the object stream into the experiment group E and the control group C as the leads arrive sequentially. Dₜ is a variable that indicates if lead lₜ is assigned to C or E. If it is assigned to E then Dₜ is 1, and if lₜ is assigned to C then Dₜ=0. The goal may be expressed as:

max Σ_{{l}_{ₜ}_{|D}_{ₜ}_{=1}}S₁ₜ (4)

Equation (4) expresses the goal of maximizing the S₁ scores for the leads in the experiment group. Further, the first-order stochastic dominance condition that control leads that have equal or better legacy scores may be expressed as:

$$\frac{\vert \{ {l}_{t} ∈ E \vert {P}_{0} ( {l}_{t} ) \leq \overline{{S}_{0}} \} \vert}{\vert \{ {l}_{t} ∈ E \} \vert} \geq \frac{\vert \{ {l}_{t} ∈ C \vert {P}_{0} ( {l}_{t} ) \leq \overline{{S}_{0}} \} \vert}{\vert \{ {l}_{t} ∈ C \} \vert} , \\ ∀ \overline{{S}_{0}} ∈ \{ {P}_{0} ( l ) \vert l ∈ L \} \qquad ( 5 )$$

Further, the condition for a may be expressed as follows:

$$\vert \frac{\vert E \vert}{\vert L \vert} - α \vert \leq ɛ \qquad ( 6 )$$

Where ε is a predefined maximum divergence from the desired α.

The system chooses undervalued leads (leads with lower S₀ than S₁) to place them in the experiment group. From the legacy perspective, the control group has the same or better quality of leads, but from the new predictive system, the experiment group has better leads.

At operation 402, the parameters for comparing predictor performance are identified, as described above. After each lead is received at operation 404, the lead is assigned to group C or group E at operation 406.

The leads are processed in group C and group E, at operation 408, by checking if the leads are converted into sales after the potential customer is contacted.

At operation 410, a statistical measurement M₀ is calculated for the results of the control group and a second statistical measurement M₁ is calculated for controls results of the experiment group. In some example embodiments, the statistical measurement is the percentage of made calls that are converted into sales within a predetermined amount of time. Other embodiments may utilize other statistical measurements to compare the performance of the tested objects (e.g., leads).

At operation 412, a check is made to determine if M₁ is better than M₀. If M₁ is better than M₀, then at operation 416, a determination is made that the new predictor is better than the legacy predictor. If M₁ is not better than M₀, then at operation 414, a determination is made that the new predictor is not proven better than the legacy predictor.

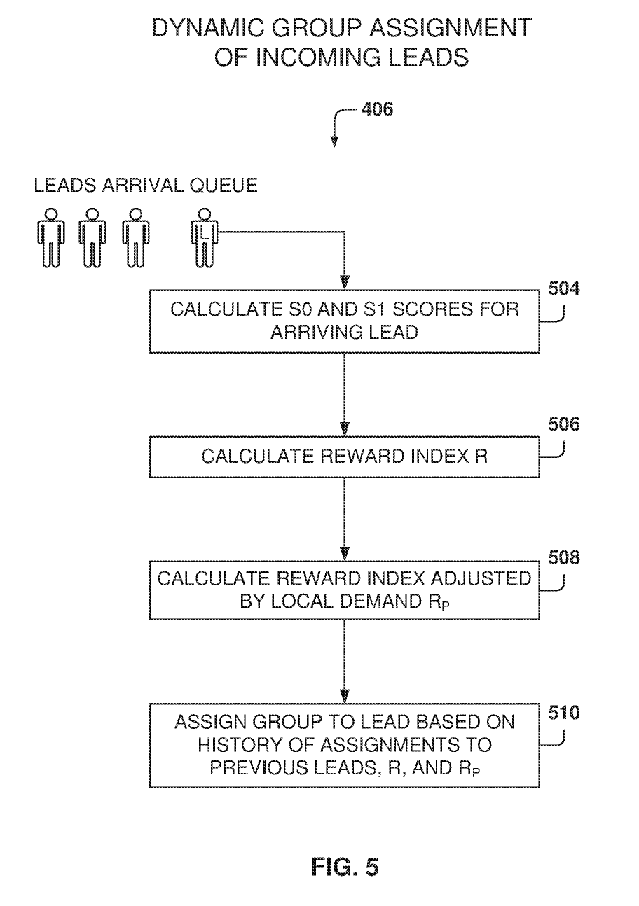

FIG. 5 illustrates the dynamic assignment 406 of incoming leads to a group, according to some example embodiments. As lead lₜ arrives, the scores S₀ and S₁ are calculated at operation 504. At operation 506, a reward index Rₚ(lₜ) is calculated for the lead lₜ according to the following equation:

$$R ( {l}_{t} ) = \frac{{S}_{1 t}}{{( 1 + {S}_{0 t} )}^{λ}} \qquad ( 7 )$$

Where λ is a coefficient to adjust the intensity of adjustment for the legacy score S₀. Further, a reward index adjusted by local demand Rₚ(lₜ) for the lead lₜ is calculated as follows:

$${R}_{p} ( {l}_{t} ) = \frac{{S}_{1}}{{( 1 + {S}_{0} )}^{\frac{λ}{p {λ}_{p}}}} \qquad ( 8 )$$

Where λ acts as a general adjustment to accommodate for the population difference in distribution of S₀ scores and S₁ scores, and λₚ acts as a local adjustment to capture the change in distribution at a certain point in time. In some embodiments, p is calculated as follows:

$$p = \frac{α}{\frac{\vert \{ {l}_{k} ∈ E \vert {P}_{0} ( {l}_{k} ) \leq {S}_{0} \} \vert}{\vert \{ {l}_{k} \vert {P}_{0} ( {l}_{k} ) \leq {S}_{0} \} \vert}} \qquad ( 9 )$$

The parameter p captures that the local demand on taking leads into the experiment group, according to the first-order stochastic dominance condition (FSD), is satisfied around S₀. The denominator is the proportion of experiment leads in the subset of leads with legacy scores lower than S₀. When FSD is not satisfied at S₀, then it is more demanding to select the lead into the experiment group, where p>1, which effectively reduces the intensity of punishment on the higher legacy score (e.g.,

$$\frac{λ}{p {λ}_{p}}$$

becomes smaller).

Further, the history of the reward index H is defined as:

Hₜ={R(lₖ)|k≤t} (10)

At time t, the decision to assign the lead lₜ is made according to the following criteria:

Dₜ(lₜ)=1, if (Rₚ(lₜ)≥R(α,Hₜ)); and

Dₜ(lₜ)=0, otherwise (11)

This means that at time t, a comparison is made between R(α, Hₜ), which is the reward index of the α-highest lead in the history Hₜ, and Rₚ(lₜ), which is the reward index adjusted by local demand for lead lₜ. Lead lₜ is selected for the experiment group if and only if Rₚ(lₜ)≥R(α, Hₜ). As discussed above, if Dₜ is 1 then lₜ is assigned to E group, and if Dₜ=0 the lₜ is assigned to C group.

Thus, there is a gradual estimation of the distributions of the incoming lead flow. The α ratio represents the overall fraction of leads selected for the experiment group. If a new lead comes in, and a may exceed the desired goal if the lead is assigned to the experiment group, the lead may still be assigned if the excess is above the predetermined threshold E. But as new leads come in, if the threshold is exceeded, then leads cannot be assigned to the experiment group until the ratio is decreased.

If the test process were to select (e.g., cherry pick) the best leads for the experiment group, then the test may not be conclusive because it could be said that the model is good at cherry-picking leads. However, since the distribution of S₀ scores is the same for both groups (or better in the control group), there is no unfair advantage from the point of view of the legacy score. Thus, if the results show that the experiment group produces better leads, then it can be categorically said that the new predictor is better than the legacy predictor.

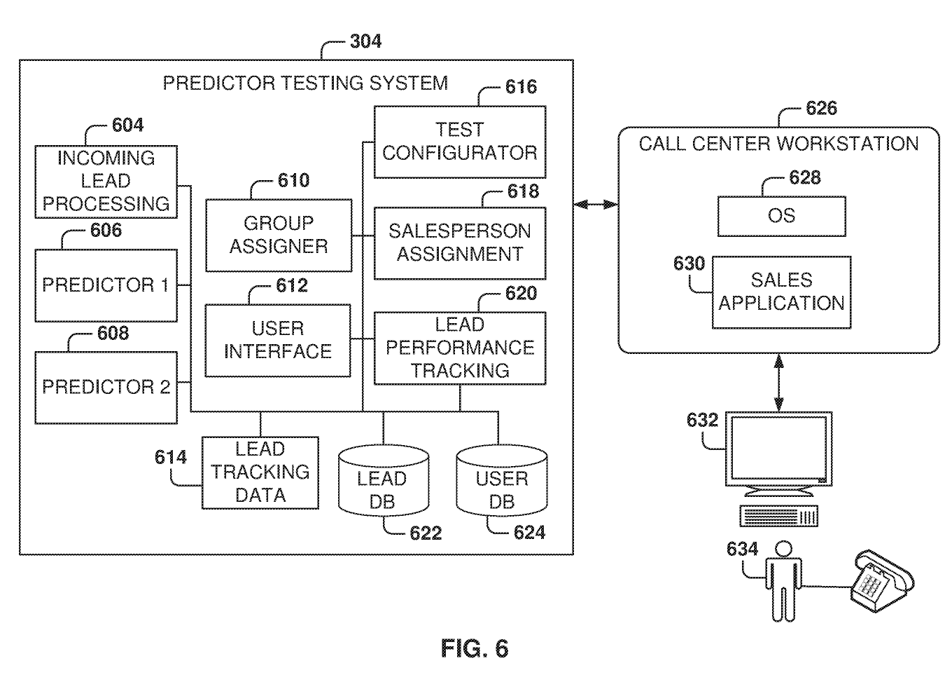

FIG. 6 is the diagram of the system for implementing embodiments. In some example embodiments, a predictor testing system 304 interacts with call-center workstations 626 being used by call center reps that contact customers identified in the lead, for example via telephone, but other means of communication are also possible, such as email, texting, etc.

In some example embodiments, the predictor testing system 304 includes a plurality of modules, which may be implemented as programs executing on a computer processor. The predictor testing system 304 includes incoming lead processing 604, a first predictor 606, a second predictor 608, a group assigner 610, the user interface 612, a test configurator 616, a salesperson assignment program 618, a lead performance tracking 620, and the storage systems that include lead tracking data 614, lead database 622, and user database 624.

The incoming lead processing 604 receives leads into the system 304 and communicates with the group assigner 610 for the processing of the leads. The test configurator 616 includes a user interface for configuring the parameters for the test, such as α and other parameters described above. The group assigner 610 processes the leads and assigns each lead to the control group or the experiment group. The first predictor 606 calculates the S₀ score and the second predictor 608 calculates the S₁ score.

The user interface 612 is used to interface with the predictor testing system 304, such as by accessing the different programs via a Windows interface. The lead performance tracking 620 monitors the outcome of the leads after a salesperson contacts a potential client and determines if the lead has been converted into a sale or not. The salesperson assignment program 618 interfaces with the different call-center workstations 626 to assign the different leads to different salespeople.

The lead tracking data 614 includes the information about the incoming leads, their assignments, scores, and final outcome. The lead database 622 stores the leads previously received by the predictor testing system 304, and the user database 624 includes information about potential customers, which may be referenced in the leads present in the lead database 622.

The call-center workstation 626 includes an operating system 628 and a sales application 630 that manages leads for the salesperson 634 interfacing with the call-center workstation 626, and that are presented in display 632.

It is noted that the embodiments illustrated in FIG. 6 are examples and do not describe every possible embodiment. Other embodiments may utilize different programs, combine the functionality of several programs, or utilize additional programs. The embodiments illustrated in FIG. 6 should therefore not be interpreted to be exclusive or limiting, but rather illustrative.

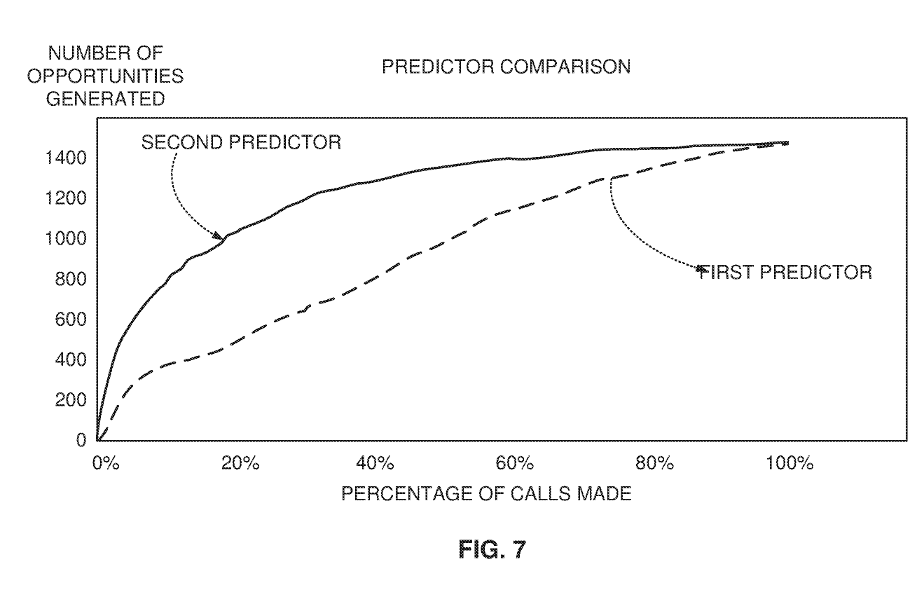

FIG. 7 is a chart showing some example results. While FIG. 7 illustrates some example results, it is not intended to be bound by these results or to be exclusive or limiting, but rather illustrative.

The chart shows the percentage of calls made on the horizontal axis, and the number of opportunities generated (e.g., the number of leads converted into sales) on the vertical axis. As discussed earlier, it may not be possible to follow-up on all incoming leads, so prioritizing the leads to follow up is important.

For example, if 20% of leads are acted upon and the sales are prioritized using the first predictor (e.g., the legacy predictor), about 400 leads are converted into sales, while if the second predictor is used, about 1000 leads are converted into sales. This represents an improvement with the new predictor of 150% over the legacy predictor. This means than if the call center only has capacity to follow up on 20% of the leads, the volume of business will more than double when using the new predictor.

As the percentage of calls made increases, the differences are decreased: if 100% of the leads are followed up, the results should be the same since there is no advantage to selecting the better leads.

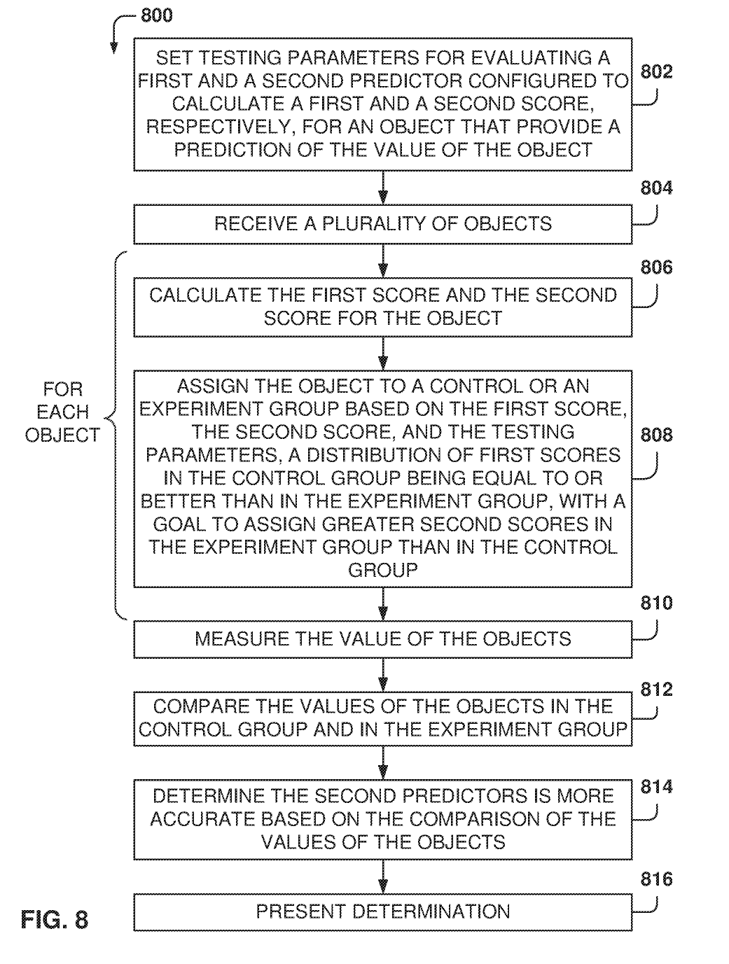

FIG. 8 is a flowchart of a method 800 for evaluating the accuracy of two predictive systems, according to some example embodiments. While the various operations in this flowchart are presented and described sequentially, one of ordinary skill will appreciate that some or all of the operations may be executed in a different order, be combined or omitted, or be executed in parallel.

At operation 802, testing parameters for evaluating a first predictor and a second predictor are set. The first predictor is configured to calculate a first score for an object and the second predictor is configured to calculate a second score for the object. The first score and the second score provide a prediction of a value of the object.

From operation 802, the method 800 flows to operation 804 for receiving, by one or more processors, a plurality of objects. For each object from the plurality of objects, operations 806 and 808 are performed.

At operation 806, the one or more processors calculate the first score and the second score for the object. Further, at operation 808, the one or more processors assign the object to one of a control group or an experiment group based on the first score, the second score, and the testing parameters. The distribution of first scores in the control group is equal to or better than the distribution of first scores in the experiment group. Further, the assigning comprises a goal to have greater second scores in the experiment group than in the control group.

At operation 810, the value of the plurality of objects is measured. From operation 810, the method 800 flows to operation 812, where the one or more processors compare the values of the objects in the control group to the values of the objects in the experiment group.

From operation 812, the method 800 flows to operation 814, where the one or more processors determine that the second predictor is more accurate than the first predictor for predicting the value of objects based on the comparison of the values of the objects. At operation 816, the one or more processors cause presentation, to a user, of the determination.

In one example, the testing parameters include a percentage of objects assigned to the experiment group and a number of objects in recent history considered for assigning the object.

In some examples, assigning the object further includes calculating a reward index R for each object and a reward index adjusted by local demand Rₚ. In some embodiments, R is calculated with equation

$$R ( object ) = \frac{second score}{{( 1 + first score )}^{λ}} ,$$

where Rₚ is calculated with equation

$${R}_{p} = \frac{second score}{{( 1 + first score )}^{\frac{λ}{p {λ}_{p}}}} ,$$

where λ and λₚ are coefficients and p is based on local demand for assigning objects to the experiment group.

In some examples, assigning the object further includes determining the group for the object based on R and Rₚ.

In some examples, comparing the values of the objects further includes calculating a statistical measure for the control group and the statistical measure for the experiment group based on the measured values of the objects in each group.

In some examples, the objects are received sequentially, where objects are sequentially assigned to the experiment group or the control group.

In some examples, each object is a lead for a potential sale, where the value of the object is based on converting the lead into a sale. In some example embodiments, measuring the value of the object is based on whether the lead is converted into a sale after contacting a user associated with the lead. Further, in some example, the second predictor is a machine-learning program for calculating the second score, the machine-learning program utilizing features related to a user associated with the lead.

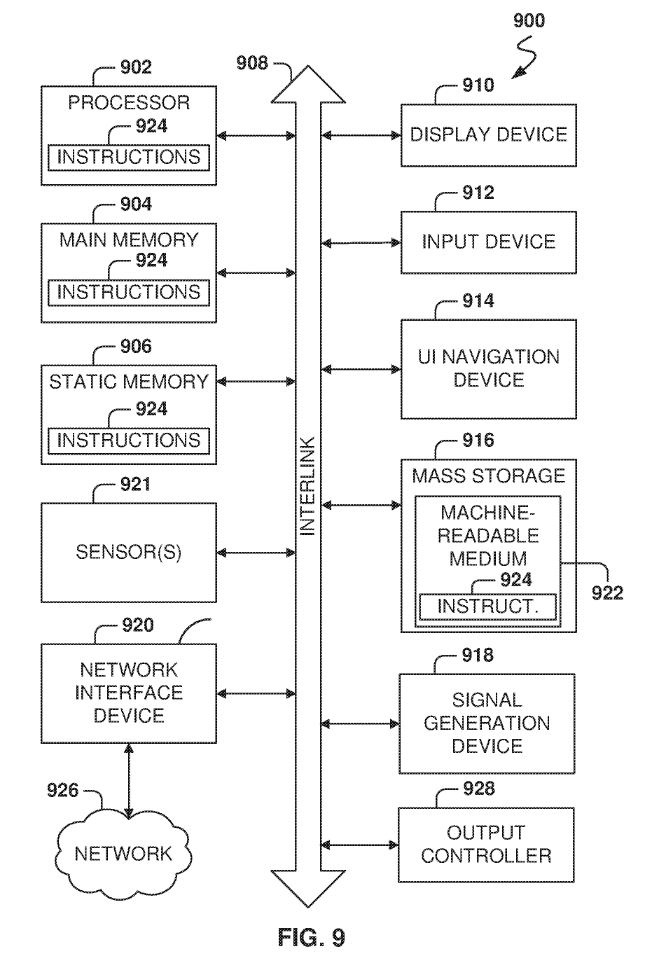

FIG. 9 is a block diagram illustrating an example of a machine upon which one or more example embodiments may be implemented. In alternative embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environment. The machine 900 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine 900 is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a display device 910, an alphanumeric input device 912 (e.g., a keyboard), and a user interface (UI) navigation device 914 (e.g., a mouse). In an example, the display device 910, input device 912 and UI navigation device 914 may be a touchscreen display. The machine 900 may additionally include a mass storage device (e.g., drive unit) 916, a signal generation device 918 (e.g., a speaker), a network interface device 920, and one or more sensors 921, such as a global positioning system (GPS) sensor, compass, accelerometer, or other sensor. The machine 900 may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 916 may include a machine-readable medium 922 on which is stored one or more sets of data structures or instructions 924 (e.g., software) embodying or utilized by any one or more of the techniques or functions described herein. The instructions 924 may also reside, completely or at least partially, within the main memory 904, within static memory 906, or within the hardware processor 902 during execution thereof by the machine 900. In an example, one or any combination of the hardware processor 902, the main memory 904, the static memory 906, or the storage device 916 may constitute machine-readable media.

While the machine-readable medium 922 is illustrated as a single medium, the term “machine-readable medium” may include a single medium or multiple media (e.g., a centralized or distributed database, and/or associated caches and servers) configured to store the one or more instructions 924.

The term “machine-readable medium” may include any medium that is capable of storing, encoding, or carrying instructions 924 for execution by the machine 900 and that causes the machine 900 to perform any one or more of the techniques of the present disclosure, or that is capable of storing, encoding or carrying data structures used by or associated with such instructions 924. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 902.11 family of standards known as Wi-Fi®, IEEE 902.16 family of standards known as WiMax®), IEEE 902.15.4 family of standards, peer-to-peer (P2P) networks, among others. In an example, the network interface device 920 may include one or more physical jacks (e.g., Ethernet, coaxial, or phone jacks) or one or more antennas to connect to the communications network 926. In an example, the network interface device 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions 924 for execution by the machine 900, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
setting testing parameters for evaluating a first predictor and a second predictor, the first predictor being configured to calculate a first score for an object, the second predictor being configured to calculate a second score for the object, the first score and the second score providing a prediction of a value of the object;
receiving, by one or more processors, a plurality of objects;
for each object from the plurality of objects:
calculating, by the one or more processors, the first score and the second score for the object; and
assigning, by the one or more processors, the object to one of a control group or an experiment group based on the first score, the second score, and the testing parameters, wherein a distribution of first scores in the control group is equal to or better than a distribution of first scores in the experiment group, wherein the assigning comprises a goal to have greater second scores in the experiment group than in the control group;
measuring, by the one or more processors, the value of the objects of the plurality of objects;
comparing, by the one or more processors, the values of the objects in the control group to the values of the objects in the experiment group;
determining, by the one or more processors, that the second predictor is more accurate than the first predictor for predicting the value of objects based on the comparison of the values of the objects; and
causing, by the one or more processors, presentation to a user of the determination.

2. The method as recited in claim 1, wherein the testing parameters comprise a percentage of objects assigned to the experiment group and a number of objects in recent history considered for assigning the object.

3. The method as recited in claim 1, wherein assigning the object further comprises:
calculating a reward index R for each object and a reward index adjusted by local demand Rₚ.

4. The method as recited in claim 3, wherein R is calculated with equation
$$R ( object ) = \frac{second score}{{( 1 + first score )}^{λ}} ,$$
wherein Rₚ is calculated with equation
$${R}_{p} = \frac{second score}{{( 1 + first score )}^{\frac{λ}{p {λ}_{p}}}} ,$$
wherein λ and λₚ are coefficients and p is based on local demand for assigning objects to the experiment group.

5. The method as recited in claim 3, wherein assigning the object further comprises:
determining the group for the object based on R and Rₚ.

6. The method as recited in claim 1, wherein comparing the values of the objects further comprises:
calculating a statistical measure for the control group and a statistical measure for the experiment group based on the measured values of the objects in each group.

7. The method as recited in claim 1, wherein the objects are received sequentially, wherein objects are sequentially assigned to the experiment group or the control group.

8. The method as recited in claim 1, wherein each object is data representing a lead for a potential sale, wherein the value of the object is based on converting the lead into a sale.

9. The method as recited in claim 8, wherein measuring the value of the object is based on whether the lead is converted into a sale after contacting a user associated with the lead.

10. The method as recited in claim 8, wherein the second predictor is a machine-learning program for calculating the second score, the machine-learning program utilizing features related to a user associated with the lead.

11. A system comprising:
a memory comprising instructions; and
one or more computer processors, wherein the instructions, when executed by the one or more computer processors, cause the one or more computer processors to perform operations comprising:
setting testing parameters for evaluating a first predictor and a second predictor, the first predictor being configured to calculate a first score for an object, the second predictor being configured to calculate a second score for the object, the first score and the second score providing a prediction of a value of the object;
receiving a plurality of objects;
for each object from the plurality of objects:
calculating the first score and the second score for the object; and
assigning the object to one of a control group or an experiment group based on the first score, the second score, and the testing parameters, wherein a distribution of first scores in the control group is equal to or better than a distribution of first scores in the experiment group, wherein the assigning comprises a goal to have greater second scores in the experiment group than in the control group;
measuring the value of the objects of the plurality of objects,
comparing the values of the objects in the control group to the values of the objects in the experiment group;
determining that the second predictor is more accurate than the first predictor for predicting the value of objects based on the comparison of the values of the objects; and
causing presentation to a user of the determination.

12. The system as recited in claim 11, wherein the testing parameters comprise a percentage of objects assigned to the experiment group and a number of objects in recent history considered for assigning the object.

13. The system as recited in claim 11, wherein assigning the object further comprises:
calculating a reward index R for each object and a reward index adjusted by local demand Rₚ, wherein R is calculated with equation
$$R ( object ) = \frac{second score}{{( 1 + first score )}^{λ}} ,$$
wherein Rₚ is calculated with equation
$${R}_{p} = \frac{second score}{{( 1 + first score )}^{\frac{λ}{p {λ}_{p}}}} ,$$
wherein λ and λₚ are coefficients and p is based on local demand for assigning objects to the experiment group.

14. The system as recited in claim 11, wherein comparing the values of the objects further comprises:
calculating a statistical measure for the control group and a statistical measure for the experiment group based on the measured values of the objects in each group.

15. The system as recited in claim 11, wherein each object is a lead for a potential sale, wherein the value of the object is based on converting the lead into a sale, wherein measuring the value of the object is based on whether the lead is converted into a sale after contacting a user associated with the lead.

16. A non-transitory machine-readable storage medium including instructions that, when executed by a machine, cause the machine to perform operations comprising:
setting testing parameters for evaluating a first predictor and a second predictor, the first predictor being configured to calculate a first score for an object, the second predictor being configured to calculate a second score for the object, the first score and the second score providing a prediction of a value of the object;
receiving a plurality of objects;
for each object from the plurality of objects:
calculating the first score and the second score for the object; and
assigning the object to one of a control group or an experiment group based on the first score, the second score, and the testing parameters, wherein a distribution of first scores in the control group is equal to or better than a distribution of first scores in the experiment group, wherein the assigning comprises a goal to have greater second scores in the experiment group than in the control group;
measuring the value of each object of the plurality of objects,
comparing the values of the objects in the control group to the values of the objects in the experiment group;
determining that the second predictor is more accurate than the first predictor for predicting the value of objects based on the comparison of the values of the objects; and
causing presentation to a user of the determination.

17. The machine-readable storage medium as recited in claim 16, wherein the testing parameters comprise a percentage of objects assigned to the experiment group and a number of objects in recent history considered for assigning the object.

18. The machine-readable storage medium as recited in claim 16, wherein assigning the object further comprises:
calculating a reward index R for each object and a reward index adjusted by local demand Rₚ, wherein R is calculated with equation
$$R ( object ) = \frac{second score}{{( 1 + first score )}^{λ}} ,$$
wherein Rₚ is calculated with equation
$${R}_{p} = \frac{second score}{{( 1 + first score )}^{\frac{λ}{p {λ}_{p}}}} ,$$
wherein λ and λₚ are coefficients and p is based on local demand for assigning objects to the experiment group.

19. The machine-readable storage medium as recited in claim 16, wherein comparing the values of the objects further comprises:
calculating a statistical measure for the control group and a statistical measure for the experiment group based on the measured values of the objects in each group.

20. The machine-readable storage medium as recited in claim 16, wherein each object is a lead for a potential sale, wherein the value of the object is based on converting the lead into a sale, wherein measuring the value of the object is based on whether the lead is converted into a sale after contacting a user associated with the lead.
